(19) United States
(12) Patent Application Publication
(10) Pub. No.: US 2018/0242620 A1
(43) Pub. Date: Aug. 30, 2018

(54) SHREDDED DRIED FOOD PRODUCTS

(71) Applicant: Ju Han Steve Song, Los Angeles, CA (US)

(72) Inventor: Ju Han Steve Song, Los Angeles, CA (US)

(21) Appl. No.: 15/442,565

(22) Filed: Feb. 24, 2017

(51) Int. Cl. A23L 13/60; A23L 5/10; A23L 5/30

(52) U.S. Cl. CPC A23L 13/60; A23V 2002/00; A23L 5/30; A23L 5/10

(57) ABSTRACT

A method of producing shredded, dried food products is provided. The method begins when a food type such as beef, pork, or chicken, or may be a fibrous vegetable, such as mushrooms. The selected food type is first heated to tenderize the food. In the case of meats, this tenderizing breaks down fibrous tissue in the food, making for easier to chew and digest. After cooking to tenderize, the food is then shredded. This shredding leaves strands of the food and does not cut across fibers, instead, the shredding follows the muscle or growing pattern of the food type. The shredded food product is then boiled for further tenderization. Some vegetables may not need further tenderization. Flavorings may also be added during the boiling process. After boiling, the food product is dried to reduce the moisture content to a desired level. This level of dryness may vary depending on the intended use of the food product and the desired storage time.

### FIELD

The present disclosure relates generally to food processing and has particular utility in connection with processing food to produce shredded meat, fish or vegetable food products.

### BACKGROUND

Dried food products are used by many individuals to provide a quick snack or to supplement a meal. Outdoor enthusiasts have relied on dried and prepared meats when camping or hiking. Beef jerky was supplied to astronauts as a snack food. Many of these dried food products have been dried meats, in many cases, cured with salt. These dried foods may have a moisture content around 25-40%, while jerky-style products may have a moisture content around 15-30%. Many of these products have a hard, dry texture and are difficult to chew.

Many cultures have prepared such dried foods. Beef jerky has been known in the United States for many years and was produced by Native Americans, as well as European settlers. Pemmican, produced by the Native Americans, is widely known. Asian cultures also have a tradition of dried meats, such as meat floss, also known as rousong. Rousong has been produced with a variety of meats including beef and pork. Typically, rousong is a dried pork product having a light and fluffy texture, similar to that of coarse cotton. In Chinese cuisine rousong has been used as a topping for many foods, as a filling in buns and pastries, and as a snack food.

Today, many people live an active lifestyle and need meals that are easy to prepare, flavorful, and healthy. Because many of the dried snack products, especially meats, are cured and dried, the sodium content may be higher than other foods. For health reasons, many individuals must keep careful track of their sodium intake and while they may like the flavor and convenience of the jerky-type products, they may not use them often. Fat content may also be a concern, and many dried food products do not reduce the fat content. The elderly may need products that are easy to chew and digest. Very dry meats, such as jerky, may be difficult for them to chew as they may be very hard.

There is a need in the art for a food product that is healthy, flavorful, easy to store for long periods, and is easy to chew and digest.

### SUMMARY

Embodiments described herein provide a method of producing shredded, dried food products. The method begins when a food type is selected. The food type may be a meat such as beef, pork, or chicken, or may be a fibrous vegetable, such as mushrooms. The selected food type is first heated to tenderize the food. In the case of meats, this tenderizing breaks down fibrous tissue in the food, making for easier to chew and digest. After cooking to tenderize, the food is then shredded. This shredding leaves strands of the food and does not cut across fibers, instead, the shredding follows the muscle or growing pattern of the food type. The shredded food product is then boiled for further tenderization. Some vegetables may not need further tenderization. Flavorings may also be added during the boiling process. After boiling, the food product is dried to reduce the moisture content to a desired level. This level of dryness may vary depending on the intended use of the food product and the desired storage time.

### BRIEF DESCRIPTION OF THE DRAWINGS

FIG. 1 is a flowchart of an overview of a method for producing a shredded dried food product, in accordance with certain embodiments of the disclosure.

FIG. 2 is a block diagram of a food processing system in accordance with embodiments of the disclosure.

FIG. 3 illustrates cutting preferences in accordance with embodiments of the disclosure.

FIG. 4 illustrates possible shredding process options after initial cooking, in accordance with certain embodiments of the disclosure.

FIG. 5 depicts chilled fats and oils after cooling, in accordance with certain embodiments of the disclosure.

FIG. 6 shows straining of the cooking juices and marinade, in accordance with certain embodiments of the disclosure.

FIG. 7A shows the finished food product, in accordance with certain embodiments of the disclosure.

FIG. 7B shows a close up of the finished food product, in accordance with certain embodiments of the disclosure.

FIG. 8 is a flow diagram of a method of producing a shredded, dried food product, in accordance with certain embodiments of the disclosure.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

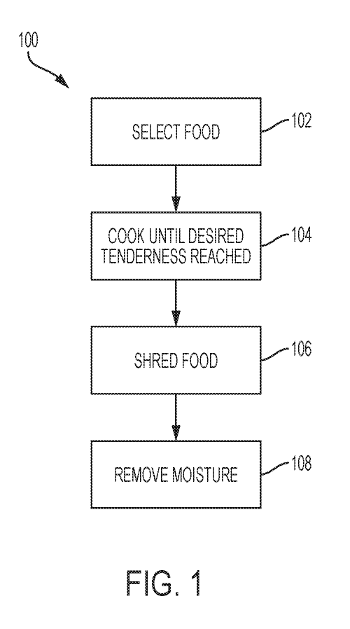

Several specific details of the invention are set forth in the following description and in FIGS. 1-8 to provide a thorough understanding of embodiments of the disclosure. One skilled in the art, however, will understand that the disclosure may additional embodiments, and that other embodiments of the disclosure may be practiced without several of the specific features or processes described below.

Other aspects, as well as features and advantages of various aspects, of the present invention will become apparent to those of skill in the art through consideration of the ensuring description, the accompanying drawings and the appended claims.

### Overview

The present disclosure describes a shredded, dried food product and methods and systems for making such products. The food product refers to animal flesh, such as beef, pork, lamb, chicken, turkey, rabbit, fish, shellfish, and may also refer to a vegetable product.

FIG. 1 is a flowchart of a basic method used to prepare a shredded, dried food product. The method, 100, begins in step 102 when the food or meat is selected. One embodiment uses an animal meat such as beef, chicken, or fish. The food selected may also be any fibrous textured vegetable such as mushrooms. Once the meat has been selected it is prepared for cooking, if necessary. For some meats, such as beef, slicing may be used to ensure that uniform cooking and marinating occurs. Other meats, such as chicken or fish, may be used whole for the initial preparation. The selected meat is then cooked in step 104 until a desired tenderness is reached. Certain vegetables may skip this process and go straight to shredding. Vegetables that may be directly shredded include: mushrooms, seaweed, lotus root, broccoli stems, and okra, to name a few. Some vegetables such as squash, carrots, yams, and zucchini may be julienned (a technique resulting in thin stick-like cuts). This initial cooking may use a variety of cooking techniques such as boiling, baking, pressure cooking, steaming or slow cooking. This initial cooking breaks down the fibers of the meat and tenderizes the meat. After initial cooking, the meat may be cooled and then shredded in step 106. This shredding is carefully performed to create the unique texture of the product. The desired texture is not chunky or sliced like a jerky product, nor is it the extremely fine filaments of a meat floss. The shredding allows the original character of the meat to remain, while providing a tender product. Once shredded the meat is dried to remove moisture in step 108. Additional flavorings, seasonings, or marinates may be added during steps 104, 106, and 108.

Another embodiment of the disclosure provides for a marinated or flavored shredded dried food product. This embodiment may also provide a vegetable product. A fibrous vegetable may be selected and then processed as described in FIG. 1 above. A further embodiment may provide for marinating in a flavored or seasoned broth and then reserving the marinade and cooking juices for the drying step to provide additional flavoring.

### Shredded Dried Food Processing System

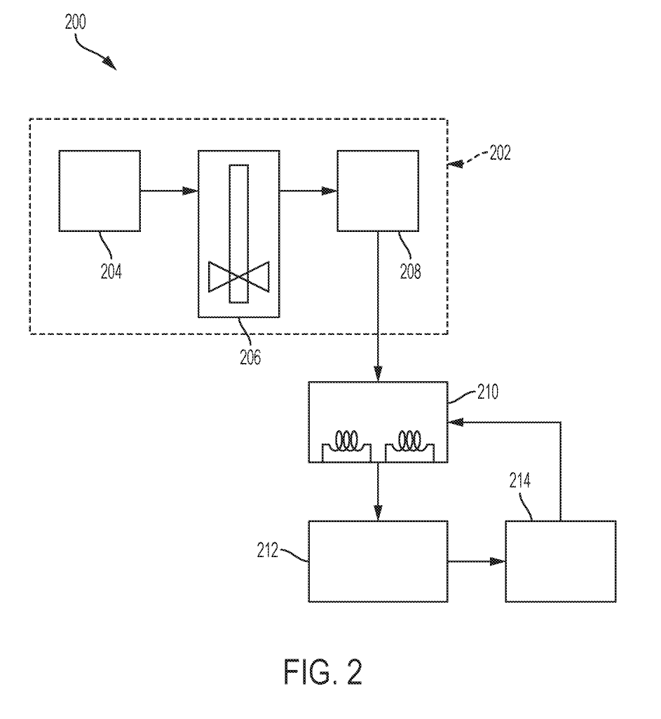

FIG. 2 schematically illustrates aspects of a food processing system 200, in accordance with an embodiment of the disclosure. As illustrated in FIG. 2 the food processing system 200 generally includes a preparation system 202. This preparation station 2020 may include a cutting or slicing station 204, a marinade blending station 206, and a margination station 208. Cutting or slicing station 204 may be used when pork, beef, lamb or other animal meat is selected. Fibrous vegetables may also be sliced at the cutting or slicing station 204. Pork, beef, and lamb may be sliced or cut into strips that may be approximately 2-3 inches in length. Chicken breasts may be left intact. Other chicken parts may be sliced if desired, or the meat may be simply removed from the bones. While 2-3 inches is suggested, cutting or slicing size does not affect the end result. The cutting station includes normal chef's knives, however, automated cutting systems may also be suitable, particularly if large batches are prepared.

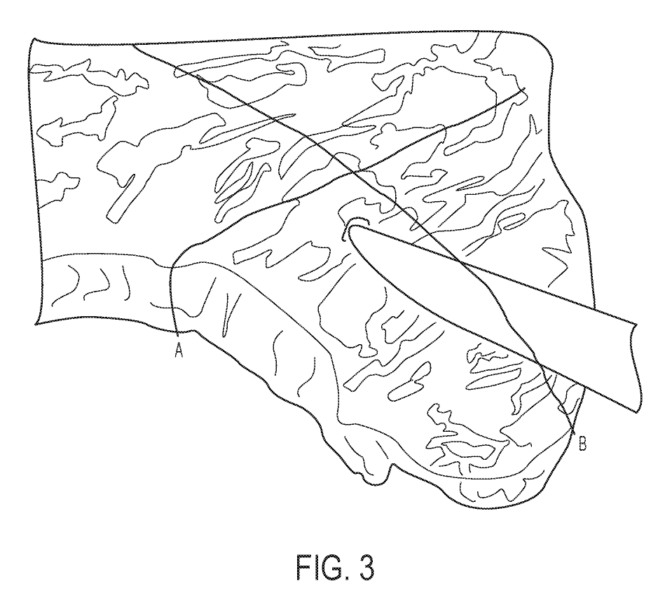

FIG. 3 depicts the possible cutting lines for a cut of beef. Line A is a preferred cutting or slicing line because this line cuts along the muscle lines, resulting in longer strands of meat. During this initial cutting stage excess fat may be trimmed or cut off before further preparation and cooking.

Preparation station 202 in FIG. 2 also includes a blender 206 for blending selected ingredients to produce a marinade. Marinating typically uses a mix of three components: salt, acid, and a flavoring, however, marinating may use only one or two of the components. Salt acts as a flavor enhancer and penetrates meat. Salt is the only ingredient that penetrates deep into the meat because it is a smaller molecule than water. Salt also reacts chemically and electrically with the water present in the meat. In addition, salt alters meat proteins to allow the meat to hold more water during cooking. Soy sauce may be used in the marinade as a source of salt. Higher concentrations of salt penetrate the meat through the process of osmosis. While salt is added to the marinade, the amount of salt added may be controlled and adjusted to produce a lower sodium shredded dried meat product. While salt is used in the marinade, the amount of salt used is less than found in beef jerky or cured ham products. Acids that may be used in a marinade include fruit juices, vinegar, buttermilk, yogurt, and even sugar-free soft drinks. A wide variety of fruit juices such as lemon, apple, white grape, orange and pineapple work well. Vinegars such as cider, sherry, balsamic, raspberry and distilled work well to add flavor. Additional flavorings, including herbs and spices commonly used in cooking may be added to the marinade. Once the marinade is blended the selected meat is marinated in the mixture at marination station 208. The amount of time spent at marination station 208 may vary with the selected meat. Chicken may be marinated with the skin removed for 1-24 hours, while pork and beef may be marinated for at 1-24 hours. Fish may be marinated for approximately 30 minutes to 1 hour.

While marinade adds flavor, it is optional, and a further embodiment may be used to produce a non-seasoned and unmarinated dried shredded meat. In this embodiment, the selected meat may be brined in a mixture of salt and water to ensure that the meat is soft and tender prior to further processing. The brine may be prepared at the blending station 206. During the brining process the fluid naturally present in the meat is exchanged with the salt water through osmosis, resulting in more liquid in the meat.

Once any desired marination or brining is completed, the meat passes to cooking station 210. This initial cooking may be accomplished with slow cooking, baking, steamed, or boiling. During the long initial cooking process the meat becomes tenders and the water-insoluble collagen that holds the muscle fibers of the meat together is converted to water-soluble gelatin. Commercial slow cookers, ovens, or pressure cookers may be used. If boiling or steaming, the water level should be monitored or a water level sensor used to ensure correct water levels. The required cooking time will vary depending on the desired degree of tenderness in the final product. Some meats may be cooked for as little as a few minutes and may be cooked for up to 24 hours, with oxtail being just one example of a meat that becomes more tender with longer cooking times. Depending on the meat, cooking time is based on how much collagen needs to break down to water soluble gelatin, or how tender the meat was before it was cooked. Typically, the desired state of tenderness allows the meat to be pulled apart using fingers or a fork, hook, or similar tool. In this state the muscle fibers are easily broken apart. Fish does not require slow cooking, pressure cooking, or long boiling periods as it contains lower collagen and elastin levels. Fish should be initially cooked by normal frying or baking methods.

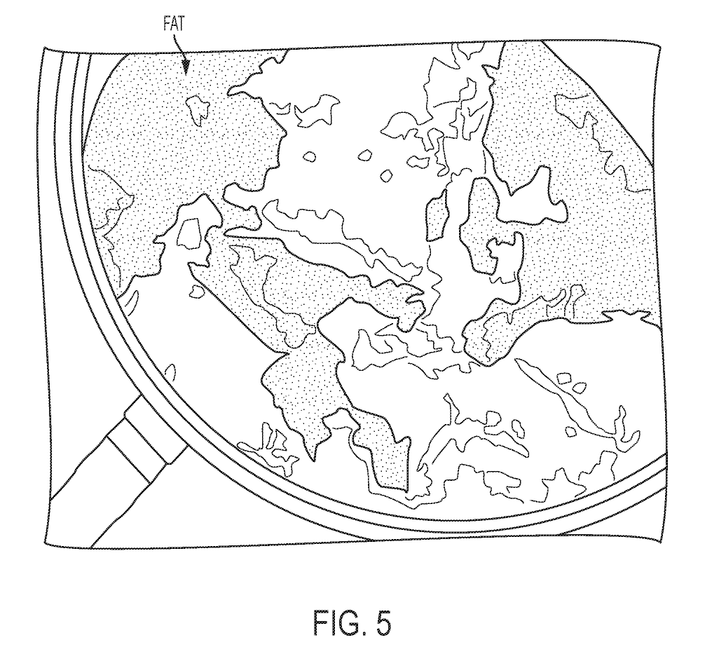

After the initial cooking the meat may be set to cool, at cooling station 212. The cooling may take place in a refrigerator or commercial cooling unit. If removing fat and oils from the cooking juice is desired, refrigeration may be chosen, as the oil will solidify for easier removal in the cooler air of a refrigeration unit. The solidified fat and oils may be scooped from the container. The meat may be removed from the cooking pan and additional fat may be removed at this time, while still soft and easy to remove from the meat. This is illustrated in FIG. 5. The liquid remaining at this stage should be reserved for the second cooking stage. This liquid is comprised of the marinade and any juices resulting from the cooking process.

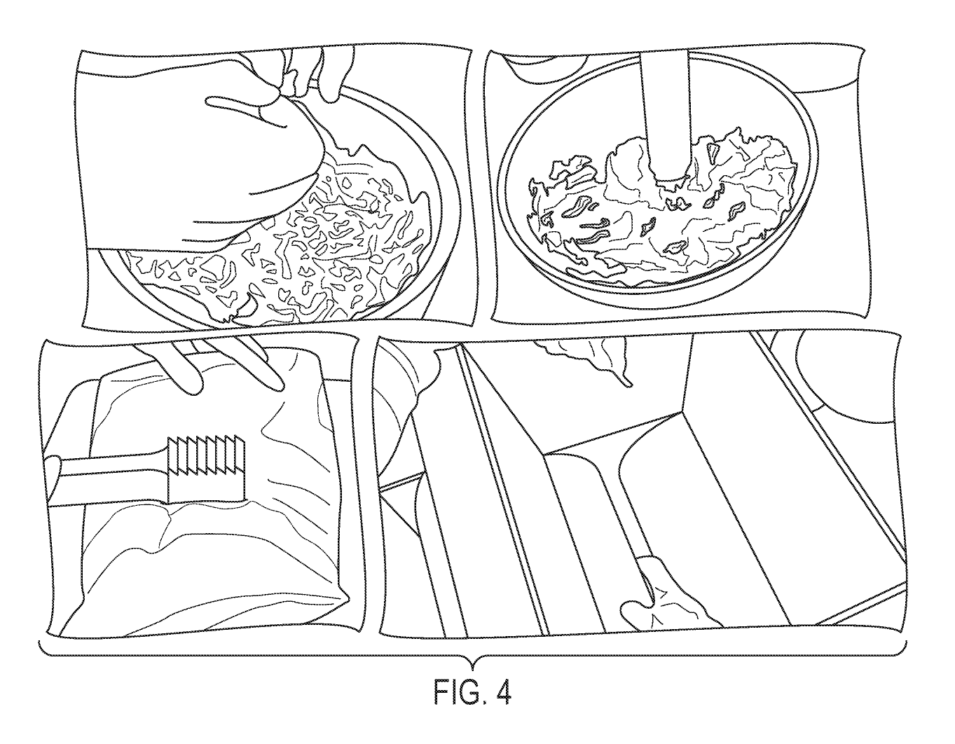

The meat may be finely shredded immediately after cooking if the optional cooling is not selected. The shredding occurs after the optional fat and oil removal process. This shredding takes place at shredding station 214 and is shown in FIG. 4. FIG. 4 also depicts methods that may be used to perform the shredding operation. In this step the meat is placed in a bowl or other container and is pounded with a wooden stick or mallet. The wooden stick is also used to spread apart the fibers of the meat. It may be useful to place the meat in a plastic bag during this stage to simplify clean-up and to ensure that the product is not contaminated. These options are illustrated in FIG. 4. Commercial meat shredders can also be another option to shred the meat.

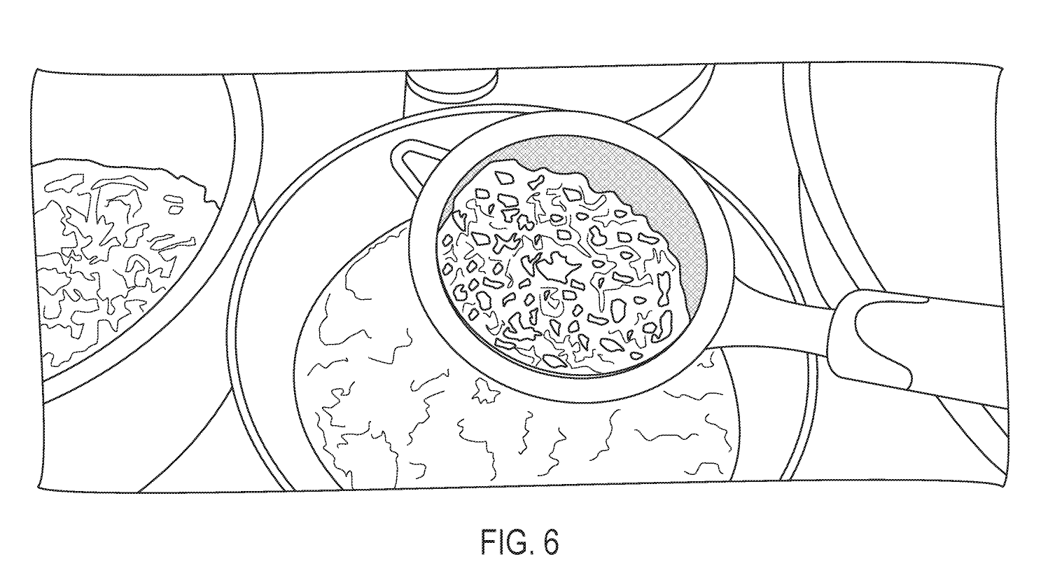

After shredding the meat it can immediately be baked or placed in a frying pan for further processing to remove moisture. At this point, it is possible to add more flavor or break down the fibers further. To accomplish these goals, the meat is boiled with the original marinade and/or other additional seasonings. The boiling may be accomplished at cooking station 210. If desired, additional spices and flavorings may be added to the reserved liquid to further enhance or vary the flavor. The de-fatting process may be cooled for 2-5 hours depending on the amount of liquid. The reserved liquid may be strained to remove any excess herbs and spices, as shown in FIG. 6. If desired, another flavoring may be used in place of the reserved liquid for a variation in flavor.

Once the boiling is complete, the meat is baked, placed in a frying pan, or similar commercial kitchen appliance, with little to no oil for a second cooking. This second cooking may use cooking station 210. The meat may be monitored so that it is cooked evenly. Additional flavors & juices may also be added during this process. It is contemplated that an automatic cooking system may be used that provided for holding the meat in a first position and then turning to a second position, to avoid burning or over-cooking. The meat may be pressed lightly during this second cooking. The goal is to avoid drying out the meat and excess pressure would result in a dried out product. At the desired finished state there is little sizzle and steam and has a slightly soft texture. It not hard, or unyielding to the touch. The finished product leaves very little moisture on tools or hands and will bounce back when lightly pressed. The final product should not be fine, or have a cotton candy texture like meat floss. It will look more like dried shredded meat. but not so hard and dry like beef jerky.

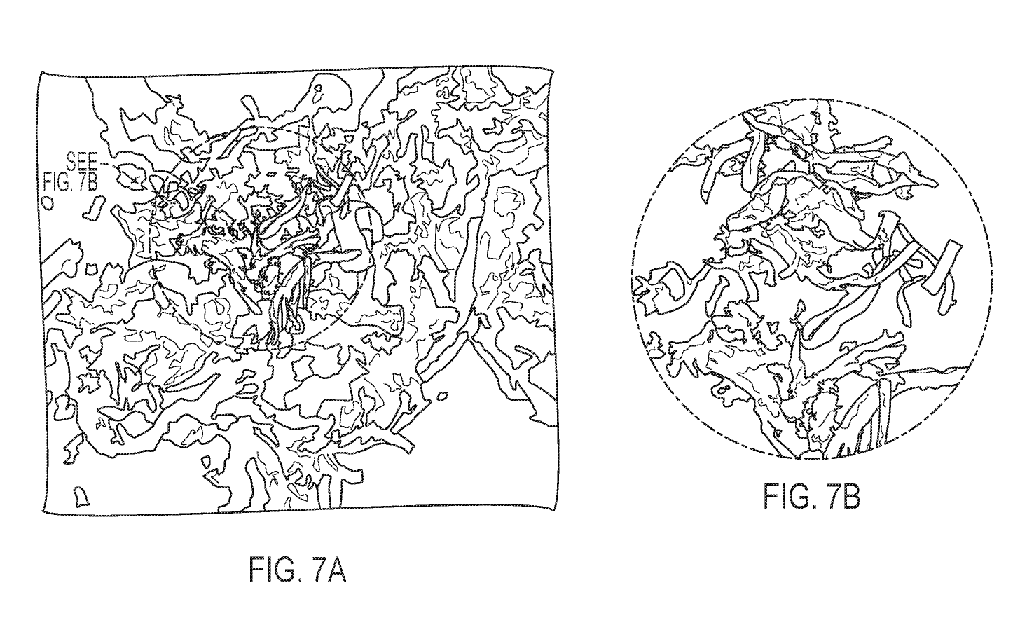

FIG. 7A shows the finished product and FIG. 7B shows a close up of the finished product. The meat still retains the strand structure of meat but will bounce back when pressed. These shreds may be eaten with no additional water or heating and may be added to soups, salads, or sandwiches as desired. The finished product may be stored or packaged in an airtight container to preserve freshness. For maximum storage life the finished meat shreds may be packaged in a vacuum sealed package. The product is sufficiently dry that it keeps well without packaging. Storage life may be extended by storing in a refrigerator after opening.

A further embodiment provides for processing fibrous vegetables using the same process described above for meats. When processing vegetables, the amount of time required for the initial and second cooking stages may vary from the timings suggested for animal meats. Note that some vegetables will skip the [104] cooking process and immediately be shredded as described above.

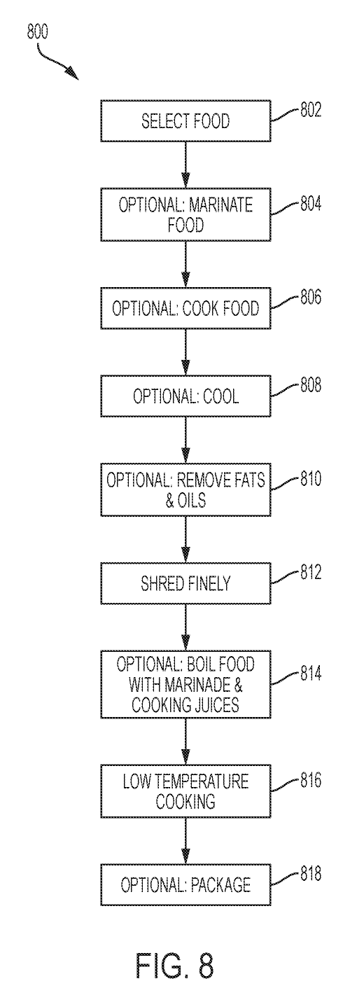

FIG. 8 provides a flowchart of a method of preparing shredded dried food products in accordance with the embodiments described herein. The method, 800, may be used with animal meats or fibrous vegetables. In step 202 the food is selected. The selection may be animal meats or fibrous vegetables. If additional flavor is desired, then in optional step 804, the food is marinated. This marinade may be chosen to add particular flavorings to the food or may be selected to enhance the natural flavor. The food is cooked in a first cooking process 806. This first cooking process is optional and may not be needed for foods that do not require multiple cooking stages to reach a desired tenderness. The cooking process selected may be boiling, baking, steamed, pressure cooking or slow cooking and is chosen to tenderize the food and break down the fibers. In optional step 808 the food may be cooled. In optional step 810 fats or oils may be removed from the food. At this point, any marinade may be strained and retained for further use. The food is then shredded finely in step 812. Then, in step 814 the food may be boiled with the reserved liquid from step 808, or an additional liquid may be chosen for the boiling. Next, in step 816, a second, low-temperature cooking is performed. This low-temperature cooking is performed to dry the food to a desired level of dryness. This level may range from 5%-99% moisture. The moisture level may be selected based on the intended storage period, or desired flavor or texture. At step 818 the finished product may be packaged if desired.

The shredded dried food product may be used as a topping or filling in many popular dished and offers a quick and easy way to add nutrition and flavor to fast meals. In addition, the shredded dried food product provides numerous advantages: it is all natural and non-refrigerated; very low in fat and oils; depending on flavorings and marinades may provide a lower-sodium alternative to jerky or meat chews; and does not require any pre-heating before use.

The above-detailed embodiments of the disclosure are not intended to be exhaustive or to limit the disclosure to the precise form discussed above. Specific embodiments of, and examples for the disclosure are described above for illustrative purposes, but those skilled in the relevant art will recognize that various equivalent modifications are possible without deviating from the disclosure. For example, although the above-noted steps are presented in a given order, alternative embodiments may perform the steps in a different order. Moreover, aspects of the various embodiments described herein can be combined to provide further embodiments.

Unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Use of the word “or” in reference to a list of items is intended to cover: (a) any of the items in the list; (b) all of the items in the list; and (c) any combination of the items in the list.

In general, the terms used in the following claims should not be construed to limit the invention to the specific embodiments disclosed in the specification unless the above-detailed description explicitly defines such terms. In addition, the inventor contemplates various aspects of the disclosure in any number of claim forms. Accordingly, the inventor reserves the right to add claims after filing the application to pursue such additional claim forms for other aspects of the disclosure.

The previous description of the disclosed exemplary embodiments is provided to enable any person skilled in the art to make or use the invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

1. A method of making a shredded, dried food product, comprising:
selecting a food type;
preparing a marinade;
cooking the food type and marinade to a desired temperature to tenderize the food type in a first cooking process;
reserving the marinade from the first cooking process;
shredding the food product;
cooking the food product to further tenderize the food product in a second cooking process; and
drying the food product with the reserved marinade to reduce a moisture content of the food product to a selected value.

2. The method of claim 1, further comprising: slicing the selected food product into strips before heating the food type to the desired temperature.

3. The method of claim 1, wherein the selected food product is a fibrous vegetable and a slicing of the selected food product is performed along the fibers of the fibrous vegetable.

4. The method of claim 1, further comprising: marinating the food type before heating the food type to a desired temperature to tenderize the food type.

5. The method of claim 4, wherein the marinade contains at least two components: a salt, an acid, and a flavor component.

6. The method of claim 5, wherein the marinade is a brine solution.

7. The method of claim 1, wherein the first cooking process uses slow cooking.

8. The method of claim 1, wherein the first cooking process uses pressure cooking.

9. The method of claim 1, wherein the first cooking process uses boiling.

10. The method of claim 1, wherein the first cooking process is different from the second cooking process.

11. A method of producing a shredded, dried meat product, comprising:
selecting a type of meat;
slicing the meat along a muscle line to produce slices;
marinating the slices in a marinade solution;
reserving the marinade solution;
cooking the marinated slices in a first cooking process until a selected temperature is reached;
shredding the cooked marinated slices to produces shreds of meat;
cooking the shredded meat with the reserved marinade solution in a second cooking process; and
cooking the meat to a selected dryness in third cooking process.

12. The method of claim 11, wherein the selected dryness is within a range of 5% moisture to 99% moisture.

13. The method of claim 11, wherein the cooking the meat to a selected dryness in a third cooking process includes pressing down on the meat during the cooking the meat to the selected dryness.

14. The method of claim 11, further comprises: adding additional flavoring agents before cooking the meat to the selected dryness in a third cooking process.

15. The method of claim 11, wherein the cooking the meat to a selected dryness in a third cooking process includes further separating shreds of the meat during the cooking the meat to the selected dryness.

16. The method of claim 11, wherein the cooking the meat to a selected dryness in a third cooking process includes turning the meat during the cooking.

17. The method of claim 11, wherein the selecting a type of meat selects fish.

18. The method of claim 11, wherein the selecting a type of meat selects shellfish.

19. The method of claim 11, wherein the selecting a type of meat selects chicken parts.

20. The method of claim 11, wherein the selecting a type of meat selects a vegetable.
